(19) United States
(12) Patent Application Publication
(10) Pub. No.: US 2012/0091054 A1
(43) Pub. Date: Apr. 19, 2012

(54) INTEGRAL OIL FILTER AND WRENCH

(76) Inventor: Andrew Pipher, Crawford, CO (US)

(21) Appl. No.: 13/181,272

(22) Filed: Jul. 12, 2011

Related U.S. Application Data
(60) Provisional application No. 61/394,644, filed on Oct. 19, 2010.

(51) Int. Cl. B01D 35/02; B01D 27/08; B23P 11/00; B01D 35/30

(52) U.S. Cl. 210/238; 29/428

(57) ABSTRACT

The present invention provides an oil filter with an integrally-attached installation/removal tool and to an apparatus and method for quickly and efficiently removing and/or installing an oil filter without the need for additional tools. An additional aspect of the present invention is to provide an oil filter installation/removal tool that may be permanently interconnected to an oil filter. Further, the apparatus may be configured to capture any oil that may leak from the oil filter or its associated engine block or oil pan during removal or replacement of the oil filter.

### CROSS REFERENCE TO RELATED APPLICATIONS

This application claims the benefit of U.S. Provisional Patent Application No. 61/394,644, filed on Oct. 19, 2010, the entire disclosure of which is incorporated by reference herein.

### FIELD OF THE INVENTION

Embodiments of the present invention are generally related to an oil filter with an integrally-attached installation/removal tool and, in particular, to an apparatus and method for quickly and efficiently removing or replacing an oil filter without the need for additional tools.

### BACKGROUND OF THE INVENTION

Oil filters remove foreign or unwanted deposits that accumulate in oil circulating in engines. The oil filters must be periodically removed and replaced (i.e. the oil filter must be “changed”) to enable continued filtering of the engine oil and to prevent engine stoppage. However, the removal and installation (collectively, the “fitting” or the “replacement”) of an oil filter presents several challenges. The oil filter is frequently placed in a confined area of the engine block, oriented at unusual angles, or blocked by other engine or vehicle components. Thus, it is difficult to obtain good sighting of the oil filter and position any required tools for its removal. Also, the oil filter commonly is changed after periodic operation of the engine, presenting the danger of heated components near the oil filter that may burn the party seeking to change the oil filter. Thus, the oil filter itself and its contained oil may be hot and present a burning hazard. In addition, oil filters are sized and shaped in a variety of formats, typically requiring a variety of distinct tools to remove and replace the oil filter. Furthermore, because such tools are applied only during removal or replacement of the oil filter, that is they are not permanently attached to the oil filter, the user must expend efforts in storing and repeatedly retrieving the tools required to perform each oil filter change.

Typically, oil filters are changed using specialized oil filter tools. Such specialized tools can work adequately for a particular and predictable oil filter and engine combination, yet not function when confronted with any other type of oil filter. As such, the party seeking to remove and replace an oil filter must maintain a supply of several specialized oil filter tools so as to change a particular oil filter. In addition, many oil filter tools require multiple tools, i.e. a specialized “oil filter wrench” to fit to particular oil filters in addition to one or more tools to turn or twist the specialized oil filter wrench to enable actual removal of the particular oil filter. Furthermore, typical oil filter changing tools require substantial access to the oil filter in order to function. However, such broad access to an oil filter is typically unavailable, particularly when the filter is a component of an engine mounted in a vehicle. For example, many oil filters mounted on car engines require access from below the car through circuitous routing behind other engine components, spanning fan belts, battery cables, and transmission components. Also, it is not uncommon that a particular specialized tool fitted for a particular oil filter and engine combination fails to function to remove and replace the targeted oil filter because the oil filter is mounted on an engine whose ancillary equipment limits access to the filter. For example, many oil filter tools designed to function to replace and remove a particular oil filter on a particular car engine fail to work when that car engine has been fitted with additional engine devices, such as a turbocharger. Also, many oil filter removal and replacement tools require the vehicle to be lifted or jacked to gain access to the filter, a process that is time-consuming that requires careful attention to ensure the vehicle remains lifted or jacked during the oil filter removal and/or replacement.

Also, available oil filter changing devices typically are of complicated construction or design, do not capture oil that escapes from the oil filter during removal, and require continuous engagement by the user. The complicated designs of many oil filter changing device or oil filter wrenches, particularly those designed to be adaptable to fit to a variety of oil filter shapes, sizes or configurations, are complicated to use, involving for example cams or multiple anchoring slots. Such designs traditionally do not wear well and are prohibitively expensive. Also, most existing oil filter changing devices do not account for the inevitable leaking or dripping of oil from the oil filter upon removal, which can present a burning hazard to the user and create an unsightly stain on a workshop or garage floor. Also, most oil filter changing device or oil filter wrenches, particularly those designed to be adaptable to fit to a variety of oil filter shapes, sizes or configurations, require the user to continuously engage or hold the oil filter, presenting difficulty to the user should, for example, his access to the oil filter be limited, his reach be near maximum, or he is simultaneously manipulating another tool to be used in coordination with the oil filter changing tool. Furthermore, existing oil filter changing devices do not allow the oil filter wrench to optionally remain attached to an oil filter continuously between replacement cycles, or to be an integral part of the oil filter itself, or otherwise be fitted or interconnected to the oil filter before the oil filter is fitted or placed on an engine. Such a feature is not present in the art and greatly simplifies and streamlines the oil filter removal and replacement process, as the oil filter simply needs to be gripped and rotated for ready removal and installation (i.e. the replacement), and in the case of an integrated oil filter tool and oil filter, immediately replaced by rotating the integrated oil filter/filter wrench tool into position on its engine.

Therefore, there is a long-felt need for an oil filter removal and replacement tool that is readily adaptable to the shape and configuration of oil filters, is of minimal profile so as to not require broad access space surrounding the filter, collects any errant oil that may leak from the oil filter during removal, is inexpensive and of simple design, and remains attached to, or integrally is a part of, an oil filter without continued engagement with a user so as to allow the tool to optionally remain on the oil filter continuously between replacement cycles or be of one-piece design with the oil filter.

The present device and method of operation addresses and solves these needs. The present invention relates to an oil filter wrench that does not require additional tools to function and can capture oil leaking from the oil filter itself. The invention does not require the user to continuously engage or hold the tool, is easily used and inexpensive to manufacture, and can remain on the oil filter or formed as an integral component of the oil filter. Furthermore, it is thin in profile allowing ready access to the oil filter in confined spaces, and reduces the time required to remove or replace an oil filter.

By way of providing additional background and context, the following references are incorporated by reference in their entireties for the purpose of explaining the nature of oil filter removal and replacement and to further describe the various tools and other apparatus commonly associated therewith: U.S. Pat. No. 7,707,912 to Sparks; U.S. Pat. No. 5,845,550 to Edwards; U.S. Pat. No. 4,643,053 to Rhodes; U.S. Pat. No. 6,375,840 to Hunter; and U.S. Pat. No. 5,924,342 to Chou.

### SUMMARY OF THE INVENTION

It is one aspect of the present invention to provide an integral oil filter tool and oil filter canister which allows an oil filter to be readily installed and/or removed without the use of additional tools. This aspect of the present invention is different than traditional oil filter tools that require multiple tools to function, are a distinctly separate component from the oil filter, are of complicated construction or operation, and/or do not function in the confined spaces typically encountered when changing an oil filter.

An additional aspect of the present invention is to provide an integral filter wrench body chamber to capture any oil that may leak from the oil filer or its mounting engine during removal or replacement of the oil filter. Existing oil filter tools do not account for capture of such leaking oil, which presents a danger of burning to the user and stains the floor of the garage or workshop of the user. Another aspect of the present invention is to provide an oil filter wrench that is not integral with an oil filter canister yet interconnects with, and remains permanently attached to, an oil filter continuously between replacement cycles.

An integral oil filter wrench and oil filter canister, or an oil filter wrench that interconnects with, and permanently attaches to, an oil filter canister, are features that are not present in the art and greatly simplifies and streamlines the oil filter removal and replacement process, as the oil filter wrench simply needs to be gripped and rotated for ready removal. That is, an oil filter may be immediately replaced by rotating the integral, or integrated, oil filter/filter wrench tool into position on an engine or oil pan. These aspects of the present oil filter wrench invention, to include an integral filter wrench body chamber to capture any oil that may leak from the oil filer as well as the ability to optionally remain attached to an oil filter continuously between replacement cycles or to be an integral component or part of the oil filter itself, do not exist today and address a long-felt need.

In the embodiment of the invention in which the oil filter wrench interconnects with, and permanently attaches to, an oil filter canister, the attachment means include, but is not limited to, glue, conventional hook and loop material (e.g. Velcro™), and interference fitting. The attachment means may also comprise adhesives such as glues, to include those requiring mixing of a plurality of components, tapes, tongue and groove joints, and mechanical connectors such as nuts and bolts, rivets, and solder. The attachment means may comprise abrasive material such as a rubber material and/or a sand-paper-like material. The attachment means may include, but is not limited to, mechanical devices such as interference fitting, chemical devices such as glue, electrical devices, magnetic devices, and electro-mechanical devices.

As an illustration of a particular mechanical means in which the oil filter wrench interconnects with, and permanently attaches to, an oil filter canister, in one embodiment of the invention the oil filter wrench fits on the exterior of an oil filter by contact of filter wrench body arms with the oil filter at the exposed end of the oil filter. One or more filter wrench band clamps are then attached around the oil filter body arms and are tightened so as to provide pressure against the oil filter and the filter wrench body arms. Torsional force is then applied to the oil filter wrench to remove the oil filter. The torsional force as applied to the oil filter wrench is facilitated by grasp of the oil filter wrench base. The torsional force may be of a clockwise or counter-clockwise direction. Such torsional force may be facilitated by use of a lower body handle. A user may grasp the lower body handle and apply a twisting motion to impart a torsional force to the oil filter wrench, thereby removing the oil filter.

Another embodiment of the invention provides a filter wrench body chamber at the filter wrench base so as to enable capture of any oil that may eject from the oil filter or its mounting engine during removal or replacement. The filter removal/installation tool may additionally be collapsible, retractable, or foldable to assume proper clearance adjacent to the engine block and other automotive accessories.

The grasping means to enable the oil filter wrench to impart rotational or torsional force to the oil filter includes, but is not limited to, geometrical shapes fitted to the lower portion of the oil filter wrench, to include a substantially circular disc, a substantially spherical knob, and a square-shaped cube. The grasping means may comprise a handle fitted to the oil filter wrench. In one embodiment, an extendable body handle allows the user additional and easier reach when removing or replacing an oil filter by providing additional length to the oil filter wrench. For additional grasping length, the extendable body handle is pulled downward toward the user substantially along the longitudinal axis of the oil filter wrench body, and then may be locked into place through a locking mechanism so as to enable the extendable body handle to impart torsional force to the filter wrench body thereby allowing the removal or replacement of the oil filter. The extendable body handle may be fitted with a spring to keep the extendable handle in an undeployed or unextended position when not pulled down by the user. The extendable body handle may be foldable and or retractable. The filter wrench may be fitted with a filter wrench body chamber at the filter wrench base to capture any oil that may leak from the oil filter or its mounting bracket during removal or replacement.

An alternate embodiment of the present invention is provided with a clamping strap and filter wrench body fingers. A clamping strap is provided that imparts pressure against the oil filter through the body arms and body fingers, thus providing a tight hold onto the oil filter. The clamping strap translates in a substantially vertical plane so as to contact the exterior of the filter wrench body, thereby imparting pressure to the exterior of the filter wrench body so as to form a tight hold onto the oil filter. The clamping strap may be moved by means of a bolt mechanism with reversible threads. The oil filter may then be removed or replaced by applying torsional force to the oil filter wrench to remove or replace the oil filter. The torsional force as applied to the oil filter wrench is facilitated by grasp of the oil filter wrench base. The torsional force may be of a clockwise or counter-clockwise direction. Such torsional force may be facilitated by use of a lower body handle. A user may grasp the lower body handle and apply a twisting motion to impart a torsional force to the oil filter wrench, thereby replacing the oil filter. The clamping strap is translated along a substantially vertical plane by movement of a threaded body handle that moves through a base nut. A locking mechanism may assist in allowing the body handle to impart a torsional force to the filter wrench body to remove or replace the oil filter. In this embodiment the filter wrench has been fitted with filter wrench body fingers which are attached to the filter wrench body arms. The filter wrench body fingers are substantially conformal to the exterior shape of the oil filter to provide additional griping of the oil filter. The filter wrench body fingers may be composed of a semi-rigid material and/or elastic material to enable conformance with the oil filter.

Another alternate embodiment of the present invention is provided with a wrench band clamp and filter wrench body fingers. This configuration may be particularly useful in situations where the oil filter is mounted so as to provide very minimal access or clearance around the oil filter diameter, so that only the oil filter wrench body may be slipped around the oil filter. The filter wrench body fingers may extend in a half-round configuration around the oil filter. The filter wrench may be composed with a filter wrench body chamber at the filter wrench base so as to enable capture of any oil that may eject from the oil filer or its mounting engine during removal or replacement.

An alternate embodiment of the present invention is provided with two wrench band clamp and a filter body whose filter wrench base is of a substantially square profile. The filter wrench may be composed with a filter wrench body chamber at the filter wrench base so as to enable capture of any oil that may eject from the oil filer or its mounting engine during removal or replacement.

A further alternate embodiment of the present invention is provided whereby engagement with the oil filter wrench by mating with the filter wrench body arms. Such mating may occur through channels or ridges in the mating area that allow mating between the oil filter and the oil filter wrench, and subsequent torsional force to be applied to by the filter wrench to remove or replace the oil filter. The filter wrench may be composed with a filter wrench body chamber at the filter wrench base so as to enable capture of any oil that may eject from the oil filer or its mounting engine during removal or replacement.

In other embodiments of the present invention, the body handle and/or filter wrench base may be fitted with an aperture to allow a standard sized tool, such as a ⅜ inch square wrench, to engage the oil filter wrench, therein providing extra torque in the event an oil filter has been over-tightened and cannot otherwise be removed. Also, in other embodiments the filter wrench body arms may be extendable, telescoping, or otherwise lengthened to assist the user in removing the oil filter.

In other embodiments of the present invention, the inner surface of the filter wrench body arms, and/or the filter wrench body fingers may be fitted with an abrasive or otherwise gripping material or gripping means to assist in the secure engagement of the filter wrench to the oil filter. Such abrasive material may include a rubber material and/or a sand-paper-like material. The gripping means may also include glue, conventional hook and loop material (e.g. Velcro™), and interference fitting. Further, the gripping means may include any known means to attach or interconnect two devices, in particular mechanical devices such as a substantially cylindrical hollow device over another substantially cylindrical device.

One of ordinary skill in the art will appreciate that embodiments of the present disclosure may allow the filter wrench to engage and remove/replace any twist-on or threaded canister fitted to an engine or mechanical device, for example, to engage and remove/replace canisters used in exhaust systems, emission systems, fuel filters, air filters, and injection systems. Also, one of ordinary skill in the art will appreciate that embodiments of the present disclosure may allow the filter wrench to form an integral part of any twist-on or threaded canister fitted to an engine or mechanical device, for example, canisters used in exhaust systems, emission systems, fuel filters, air filters, and injection systems.

One of ordinary skill in the art will appreciate that embodiments of the present disclosure may be constructed of materials known to provide, or predictably manufactured to provide the various aspects of the present disclosure. These materials may include, for example, stainless steel, titanium alloy, aluminum alloy, chromium alloy, and other metals or metal alloys. These materials may also include, for example, carbon fiber, ABS plastic, polyurethane, and other fiber-encased resinous materials, synthetic materials, polymers, and natural materials. The oil filter wrench and its elements could be flexible, semi-rigid, or rigid and made of materials such as stainless steel, titanium alloy, aluminum alloy, chromium alloy, and other metals or metal alloys, carbon fiber, ABS plastic, polyurethane, and other fiber-encased resinous materials, synthetic materials, polymers, and natural materials.

In one embodiment of the present invention, the oil filter and the fitting (i.e. installation and/or removal) device are integral, that is, they are permanently connected. More specifically, an oil filter canister and integral tool comprises a body having an upper end, a lower end, and an oil filter positioned therein, the oil filter canister adapted to filter particulate matter from oil used in an internal combustion engine; a threaded engagement portion positioned proximate to the upper end which is adapted to interconnect the oil filter canister to an engine block and/or an oil pan; and an integral tool interconnected to the body, the integral tool including a gripping portion and extending substantially downwardly from the oil filter canister to allow grasping and adapted to provide rotational movement by the user to the oil filter canister and integral tool for selectively installing and removing the oil filter canister to an engine block and/or an oil pan.

In another embodiment of the device, the oil filter and the fitting device are selectively interconnected, and are configured to optionally remain on the engine after oil filter changes and/or between oil changes. More specifically, an oil filter fitting apparatus adapted for permanent attachment to an oil filter canister comprises an attachment means for permanently interconnecting an oil filter fitting apparatus to an oil filter canister and a grasping means to allow a user to rotate the oil filter fitting apparatus and secure the oil filter canister to an engine block and/or an oil pan.

In one method of permanently interconnecting an oil filter fitting apparatus to an oil filter canister, a user performs the steps of positioning an oil filter fitting apparatus near to an oil filter canister; engaging the oil filter fitting apparatus with the oil filter canister in which the oil filter fitting apparatus engages an exterior portion of the oil filter canister; and permanently affixing the oil filter fitting apparatus to the oil filter canister in which the oil filter fitting apparatus remains interconnected to the oil filter canister before and after installation of the oil filter canister to an engine block and/or an oil pan.

This Summary of the Invention is neither intended nor should it be construed as being representative of the full extent and scope of the present disclosure. The present disclosure is set forth in various levels of detail in the Summary of the Invention as well as in the attached drawings and the Detailed Description of the Invention, and no limitation as to the scope of the present disclosure is intended by either the inclusion, or non-inclusion of elements, components, etc. in this Summary of the Invention. Additional aspects of the present disclosure will become more readily apparent from the Detailed Description, particularly when taken together with the drawings.

The above-described benefits, embodiments, and/or characterizations are not necessarily complete or exhaustive, and in particular, as to the patentable subject matter disclosed herein. Other benefits, embodiments, and/or characterizations of the present disclosure are possible utilizing, alone or in combination, as set forth above and/or described in the accompanying figures and/or in the description herein below. However, the Detailed Description of the Invention, the drawing figures, and the exemplary claim set forth herein, taken in conjunction with this Summary of the Invention, define the invention.

### BRIEF DESCRIPTION OF THE DRAWINGS

The accompanying drawings, which are incorporated in and constitute a part of the specification, illustrate embodiments of the invention and together with the general description of the invention given above, and the detailed description of the drawings given below, serve to explain the principals of this invention.

FIG. 1 depicts a front elevation view of an oil filter and associated oil filter wrench in one embodiment of the present invention;

FIG. 2 depicts a front elevation view of an alternate embodiment of the present invention with an extendable body handle;

FIG. 3 depicts a front elevation view of the oil filter wrench in an alternate embodiment of the present invention with a clamping collar strap;

FIG. 4 depicts a front elevation view of an oil filter wrench in an alternate embodiment of the present invention with body fingers;

FIG. 5 depicts a front elevation view of the oil filter wrench in an alternate embodiment of the present invention wherein the removal tool has a substantially planar bottom;

FIG. 6 depicts a front elevation view of the oil filter wrench in an alternate embodiment of the present invention where the oil filter is integral with the filter wrench.

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

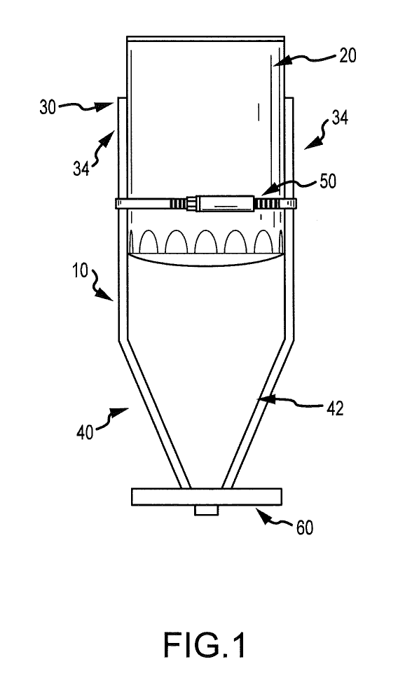

FIGS. 1-6 show various embodiments of the oil filter wrench 10 of the present invention. The filter wrench 10 is used to remove and install/replace an oil filter 20. The oil filter 20 is generally of a cylindrical shape, and is mounted to an engine such that only one of its ends is exposed. The oil filter 20 is removed or installed/replaced through application of torsional force to its exposed end. The process of both removing an oil filter 20 and then replacing/installing a new oil filter 20 is traditionally termed changing an oil filter.

Referring to FIG. 1, the elements of the oil filter wrench 10 include a filter wrench body 30, a plurality of filter wrench body arms 34, a filter wrench base 40, and one or more filter wrench band clamps 50. To remove an oil filter 20, the filter wrench 10 fits on the exterior of the oil filter 20 by contact of the filter wrench body arms 34 with the oil filter 20 at the exposed end of the oil filter 20. One or more filter wrench band clamps 50 are then attached around the oil filter body arms 34 and are tightened so as to provide pressure against the oil filter 20 and the filter wrench body arms 34. Torsional force is then applied to the oil filter wrench 10 to remove the oil filter 20. The torsional force as applied to the oil filter wrench 10 is facilitated by grasp of the oil filter wrench base 40. The torsional force may be of a clockwise or counter-clockwise direction. Such torsional force may be facilitated by use of a lower body handle 60. A user may grasp the lower body handle 60 and apply a twisting motion to impart a torsional force to the oil filter wrench 10, thereby removing the oil filter 10.

Still referring to FIG. 1, to replace an oil filter 10 after removal of an oil filter 10 as described above, the filter wrench 10 first fits on the exterior of the replacement oil filter 20 by contact of the filter wrench body arms 34 with the oil filter 20 at the exposed end of the oil filter 20. The filter wrench body arms may be dimensioned to provide overall shorter or longer reach or height of the filter wrench 10, so as to facilitate use of the oil filter wrench 10. One or more filter wrench band clamps 50 are then attached around the oil filter body arms 34 and are tightened so as to provide pressure against the oil filter 20 and the filter wrench body arms 34. Torsional force is then applied to the oil filter wrench 10 to remove the oil filter 20. The torsional force as applied to the oil filter wrench 10 is facilitated by grasp of the oil filter wrench base 40. The torsional force may be of a clockwise or counter-clockwise direction. Such torsional force may be facilitated by use of a lower body handle 60. A user may grasp the lower body handle 60 and apply a twisting motion to impart a torsional force to the oil filter wrench 10, thereby replacing the oil filter 10. The oil filter wrench tool 10 may then be left on the oil filter 20 after replacing or installing a new oil filter 20, thereby being immediately available to remove the oil filter 20 upon the next oil filter 20 changing cycle. In this manner of operation, the oil filter wrench 10 greatly simplifies and streamlines the oil filter 20 removal and replacement process, as the oil filter 20 simply needs to be gripped and rotated for ready removal. Similarly, the oil filter wrench tool 10 may be attached to an oil filter 20 before the oil filter 20 is attached to an engine or mechanical device.

Still referring to FIG. 1, the filter wrench 10 may be composed with a filter wrench body chamber 42 at the filter wrench base 40 so as to enable capture of any oil that may eject from the oil filer 20 or its mounting engine during removal or replacement. The body handle 60 and/or filter wrench base 40 may be fitted with an aperture to allow a standard sized tool, such as a ⅜ inch square wrench, to engage the oil filter wrench 10, therein providing extra torque in the event an oil filter 20 has been over-tightened and cannot otherwise be removed.

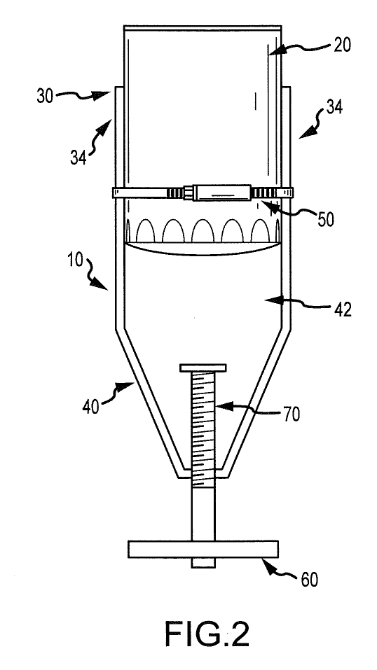

Referring to FIG. 2, an alternate embodiment of the present invention is provided with an extendable body handle 70. In this embodiment, otherwise substantially similar to the embodiment just described in FIG. 1, an extendable body handle 70 allows the user additional and easier reach when removing or installing/replacing an oil filter 20 by providing additional length to the oil filter wrench 10. For additional grasping length, the extendable body handle 70 is pulled downward toward the user substantially along the longitudinal axis of the oil filter wrench body 30, and then may be locked into place through a locking mechanism so as to assist in enabling the extendable body handle to impart torsional force to the filter wrench body 30 thereby allowing the removal or replacement of the oil filter 20. The extendable body handle 70 may be configured with a spring so as to allow return to a nominal or specified position. The filter wrench 10 may be composed with a filter wrench body chamber 42 at the filter wrench base 40 so as to enable capture of any oil that may eject from the oil filer 20 or its mounting engine during removal or replacement.

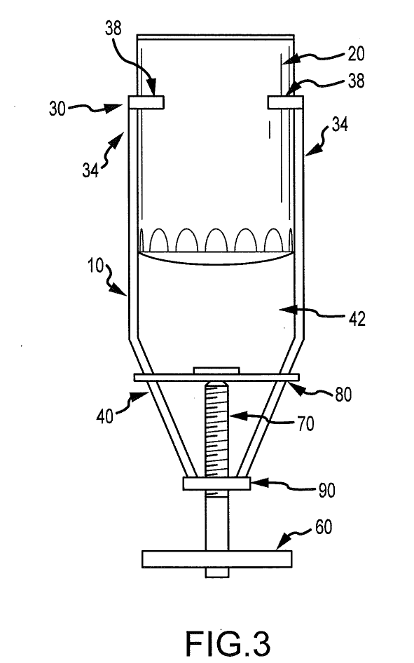

Referring to FIG. 3, an alternate embodiment of the present invention is provided with a clamping strap 80 and filter wrench body fingers 38. In this embodiment, a clamping strap 80 is provided that imparts pressure against the oil filter 20 through the body arms 34, thus providing a tight hold onto the oil filter 20. The clamping strap 80 translates in a substantially vertical plane so as to contact the exterior of the filter wrench body 30, thereby imparting pressure to the exterior of the filter wrench body 30 so as to form a tight hold onto the oil filter 20. The oil filter 20 may then be removed or installed/replaced by applying torsional force to the oil filter wrench 10 to remove or install/replace the oil filter 20. The torsional force as applied to the oil filter wrench 10 is facilitated by grasp of the oil filter wrench base 40. The torsional force may be of a clockwise or counter-clockwise direction. Such torsional force may be facilitated by use of a lower body handle 60. A user may grasp the lower body handle 60 and apply a twisting motion to impart a torsional force to the oil filter wrench 10, thereby replacing the oil filter 10.

Still referring to FIG. 3, the clamping strap 80 is translated along a substantially vertical plane by movement of a threaded body handle 60 that moves through a base nut 90. A locking mechanism may assist in allowing the body handle 60 to impart a torsional force to the filter wrench body 30 to remove or replace the oil filter 20.

Still referring to FIG. 3, in this embodiment the filter wrench 10 has been fitted with filter wrench body fingers 38 which are attached to the filter wrench body arms 34. The filter wrench body fingers 38 are substantially conformal to the exterior shape of the oil filter 20 to provide additional griping of the oil filter 20. The filter wrench body fingers may be composed of a semi-rigid material and/or elastic material to enable conformance with the oil filter 20.

Still with respect to FIG. 3, to remove or replace an oil filter 20, the filter wrench 10 fits on the exterior of the oil filter 20 by contact of the filter wrench body arms 34 with the oil filter 20 at the exposed end of the oil filter 20. The clamping strap 80 is then translated substantially in a vertical plane by movement of a threaded body handle 60 that moves through a base nut 90. The base nut 90 may be configured with reverse threads. A locking mechanism may then be engaged to assist in allowing the base handle to be used to impart torsional force to the filter wrench 10 and thereby remove or replace the oil filter 20. The torsional force may be of a clockwise or counter-clockwise direction. One or more filter wrench band clamps 50 may also be attached around the oil filter body arms 34 and tightened so as to provide additional pressure against the oil filter 20 and the filter wrench body arms 34. The filter wrench 10 may be composed with a filter wrench body chamber 42 at the filter wrench base 40 so as to enable capture of any oil that may eject from the oil filer 20 or its mounting engine during removal or replacement.

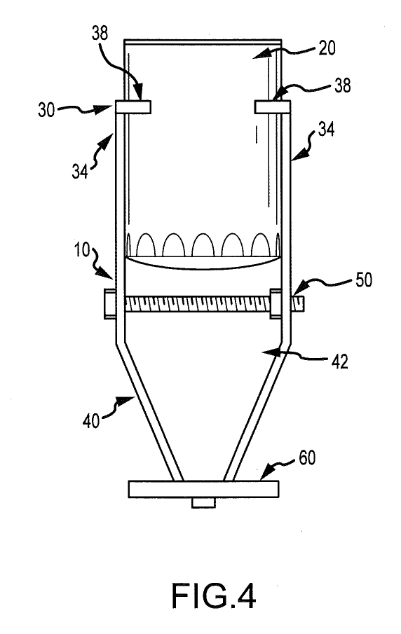

Referring to FIG. 4, an alternate embodiment of the present invention is provided with a wrench band clamp 50 and filter wrench body fingers 38. The filter wrench body fingers 38 are conformal with the external geometry of the oil filter 20, such as a circular arc shape. This configuration may be particularly useful in situations where the oil filter 20 is mounted so as to provide very minimal access or clearance around the oil filter diameter, so that only the oil filter wrench body 30 may be slipped around the oil filter 20. The filter wrench 10 may be composed with a filter wrench body chamber 42 at the filter wrench base 40 so as to enable capture of any oil that may eject from the oil filter 20 or its mounting engine during removal or replacement.

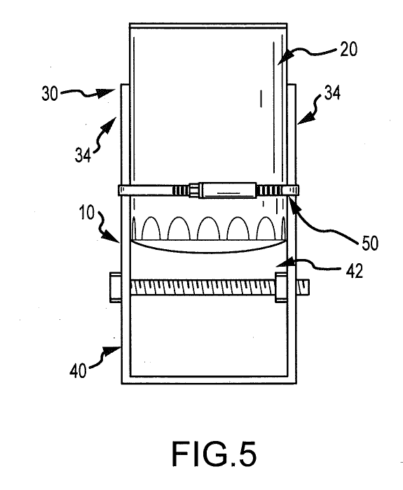

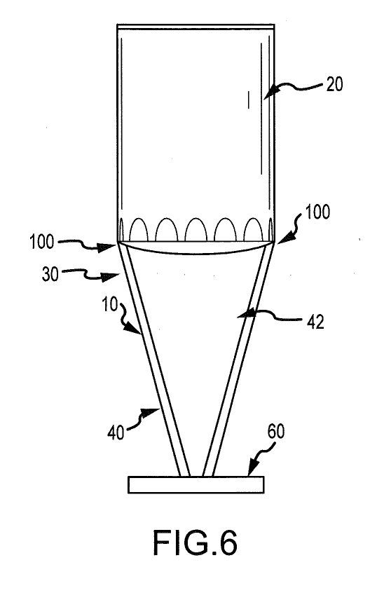

Referring to FIG. 5, an alternate embodiment of the present invention is provided with two wrench band clamp 50 and a filter body 30 whose filter wrench base 40 is of a substantially square profile. The filter wrench 10 may be composed with a filter wrench body chamber 42 at the filter wrench base 40 so as to enable capture of any oil that may eject from the oil filer 20 or its mounting engine during removal or replacement. Referring to FIG. 6, an alternate embodiment of the present invention is provided whereby the oil filter wrench 10 is integral with the oil filter 20. That is, the oil filter wrench 10 and the oil filter 20 are of one-piece construction. Such a feature greatly simplifies and streamlines the oil filter removal and replacement process, as the oil filter simply needs to be gripped and rotated for ready removal or replacement/installation. The filter wrench portion 10 may be fitted with a filter wrench body chamber 42 at the filter wrench base 40 so as to enable capture of any oil that may eject from the oil filter 20 or its mounting engine during removal or replacement. The embodiment of FIG. 6 comprises configurations adapted for use with specific makes or models of oil filters 20 and/or combinations of makes or models of engines or other mechanical devices with oil filters 20.

The oil filter wrench 10 and its elements, such as the filter wrench band clamps 50, could be flexible, semi-rigid, or rigid and made of materials such as stainless steel, titanium alloy, aluminum alloy, chromium alloy, and other metals or metal alloys, carbon fiber, ABS plastic, polyurethane, and other fiber-encased resinous materials, synthetic materials, polymers, and natural materials. In particular, the filter wrench band clamps 50 could also be made of any reclosable bond such as Velcro®, or could be formed as straps with locking heads such as those used as locking straps on luggage tags or as cuffs used in law enforcement.

One of ordinary skill in the art will appreciate that embodiments of the present disclosure as provided in FIGS. 1-6 may allow the filter wrench 10 to engage and remove/replace any twist-on or threaded canister fitted to an engine or mechanical device, for example, to engage and remove/replace canisters used in exhaust systems, emission systems, fuel filters, air filters, and injection systems, in addition to oil filter 20. Also, one of ordinary skill in the art will appreciate that embodiments of the present disclosure may allow the filter wrench to form an integral part of any twist-on or threaded canister fitted to an engine or mechanical device, for example, canisters used in exhaust systems, emission systems, fuel filters, air filters, and injection systems.

| Reference No. | Component |
|---|---|
| 10 | filter wrench |
| 20 | oil filter |
| 30 | filter wrench body |
| 34 | plurality of filter wrench body arms |
| 38 | Filter wrench body fingers |
| 40 | filter wrench base |
| 42 | filter wrench body chamber |
| 50 | filter wrench band clamp |
| 60 | body handle |
| 70 | extendable body handle |
| 80 | clamping strap |
| 90 | base nut |
| 100 | mating area |

What is claimed is:

1. An oil filter canister and integral tool, comprising:
a body having an upper end, a lower end, and an oil filter positioned therein, the oil filter canister adapted to filter particulate matter from oil used in an internal combustion engine;
a threaded engagement portion positioned proximate to the upper end which is adapted to interconnect the oil filter canister to at least one of an engine block and an oil pan;
an integral tool interconnected to the body, the integral tool including a gripping portion; and
wherein the integral tool extends substantially downwardly from the oil filter canister to allow grasping and is adapted to provide rotational movement by the user to the oil filter canister and integral tool for selectively installing and removing the oil filter canister to the at least one of an engine block and an oil pan.

2. The device of claim 1, wherein the lower end of the oil filter canister and integral tool further comprises a body chamber that substantial captures fluid discharged from the oil filter canister.

3. The device of claim 2, wherein the body chamber is at least one of retractable and foldable.

4. The device of claim 1, wherein the lower end of the oil filter canister and integral tool further comprises a body handle that when rotated by the user imparts a substantially torsional force to the oil filter canister and integral tool.

5. The device of claim 4, wherein the body handle is at least one of retractable and foldable.

6. The device of claim 4, wherein the body handle is extendable.

7. The device of claim 1, wherein the upper end of the oil filter canister and integral tool is of substantially cylindrical shape and the lower end is of substantially conical shape.

8. The device of claim 1, wherein the oil filter canister and integral tool are of substantially cylindrical shape.

9. An oil filter fitting apparatus adapted for permanent attachment to an oil filter canister, comprising:
attachment means for permanently interconnecting said oil filter fitting apparatus to an oil filter canister; and
grasping means to allow a user to rotate said oil filter fitting apparatus and secure the oil filter canister to at least one of an engine block and an oil pan.

10. The device of claim 9, wherein the oil filter fitting apparatus further comprises a capturing means for substantially collecting fluid discharged from the oil filter canister.

11. The device of claim 10, wherein the capturing means for substantially collecting fluid discharged from the oil filter canister comprises a body chamber that is at least one of retractable and foldable.

12. The device of claim 9, wherein the grasping means for rotationally interconnecting the oil filter canister to at least one of an engine block and an oil pan comprises a body handle that when rotated imparts a substantial torsional force to the oil filter canister.

13. The device of claim 12, wherein the body handle is at least one of retractable and foldable.

14. The device of claim 9, wherein the oil filter fitting apparatus comprises a substantially conical shape and substantially cylindrical shape.

15. The device of claim 9, wherein the attachment means for permanently interconnecting the oil filter fitting apparatus to the oil filter canister comprises one or more body arms and one or more clamps.

16. The device of claim 9, wherein the attachment means for permanently interconnecting the oil filter fitting apparatus to the oil filter canister are selected from the group consisting of glue, clamps, hook and loop material, and interference fits.

17. A method for permanently interconnecting an oil filter fitting apparatus to an oil filter canister, comprising the steps of:
positioning an oil filter fitting apparatus proximate to an oil filter canister;
engaging the oil filter fitting apparatus with the oil filter canister, wherein the oil filter fitting apparatus engages an exterior portion of the oil filter canister; and
permanently affixing the oil filter fitting apparatus to the oil filter canister, wherein the oil filter fitting apparatus remains interconnected to the oil filter canister before and after installation of the oil filter canister to at least one of an engine block and an oil pan.

18. The method of claim 17, wherein the step of permanently affixing the oil filter fitting apparatus to the oil filter canister comprises elements of glue, clamps, hook and loop material, and interference fits.

19. The method of claim 17, further comprising substantially collecting fluid discharged from the oil filter canister.

20. The method of claim 19, wherein the step of substantially collecting fluid discharged from the oil filter canister comprises a body chamber element.
